(19) United States
(12) Patent Application Publication
(10) Pub. No.: US 2024/0409744 A1
(43) Pub. Date: Dec. 12, 2024

(54) Lignin-based structural materials and methods of making the same

(71) Applicants: Alliance for Sustainable Energy, LLC, Golden, CO (US); Colorado School of Mines, Golden, CO (US)

(72) Inventors: Paul William MEYER, Lakewood, CO (US); Nicholas A. RORRER, Golden, CO (US); Kyle Edward O’Neil FOSTER, Denver, CO (US); Lori Elizabeth TUNSTALL, Golden, CO (US); Robert David ALLEN, Golden, CO (US); Jingying HU, Arvada, CO (US)

(21) Appl. No.: 18/673,947

(22) Filed: May 24, 2024

Related U.S. Application Data
(63) Continuation-in-part of application No. 18/512,420, filed on Nov. 17, 2023.
(60) Provisional application No. 63/505,638, filed on Jun. 1, 2023.

(51) Int. Cl. C08L 97/00; C04B 18/26; C04B 24/06; C04B 26/04; C04B 40/00; C04B 111/27; C08K 3/013; C08K 5/092

(52) U.S. Cl. CPC C08L 97/005; C04B 18/26; C04B 24/06; C04B 26/04; C04B 40/0071; C04B 40/0082; C08K 3/013; C08K 5/092; C04B 2111/27; C04B 2201/50

(57) ABSTRACT

Among other things, a lignin-based structural material and a method of making the lignin-based structural material are described. The method of making this lignin-based structural material may utilize significantly less energy than the manufacture of traditional structural materials. The lignin-based structural material may include lignin, an acid, a polymer, and an aggregate filler. The method of making this lignin-based structural material may also be capable of mitigating carbon dioxide by sequestering carbon (in the form of the lignin) and thus offsetting emissions from traditional structural material manufacturing.

### CROSS-REFERENCE TO RELATED APPLICATIONS

This application claims priority to U.S. Provisional Patent Application No. 63/505,638 filed on Jun. 1, 2023 and is a continuation-in-part of U.S. Nonprovisional patent application Ser. No. 18/512,420 filed Nov. 17, 2023, the contents of each of which are incorporated herein by reference in their entirety.

### CONTRACTUAL ORIGIN

This invention was made with United States government support under Contract No. DE-AC36-08GO28308 awarded by the U.S. Department of Energy. The United States government has certain rights in this invention.

### BACKGROUND

Traditional structural materials like concrete, clay brick, steel, and engineered wood emit a significant amount of carbon dioxide (approximately 7% of the world's total carbon dioxide emissions) and other pollutants (e.g., nitrogen oxides (NOx), sulfur oxides (SOx), and particulate matter (PM2.5)). This is primarily due to the high temperatures (approximately 1500° C.) needed for manufacturing and the reaction byproducts generated by converting calcium carbonate to lime-based (CaO) products. Significant fossil fuel usage is required for the processing and manufacture of traditional structural materials. Thus, there remains a need for structural material with less carbon emissions during the manufacturing process.

### SUMMARY

An aspect of the present disclosure is a method including combining a lignin, an acid, and a polymer to form a lignin-based precursor mixture, mixing the lignin-based precursor mixture and an aggregate filler resulting in a lignin composite, compressing the lignin composite, and heating the lignin composite resulting in a lignin-based structural material. In some embodiments, the lignin is dealkaline lignin. The precursor mixture may be thermoset, e.g., unmeltable. In some embodiments, the acid is a citric acid, a hydroxyl-containing acid polymer, and/or a carboxylic acid-containing polymer. In some embodiments, the polymer is poly(vinyl alcohol), cellulosic materials, hydroxyl-terminated poly(ethylene glycol), and/or poly(acrylic acid). In some embodiments, the aggregate filler is sand, silica, sandstone, limestone, clay, and/or gravel. In some embodiments, the heating includes drying the lignin composite, and curing the lignin composite. In some embodiments, the drying includes exposing the lignin composite to ambient conditions. In some embodiments, the drying is performed at a temperature of less than 100° C. In some embodiments, the curing is performed at a temperature of less than approximately 300° C. In some embodiments, the compressing includes exposing the lignin composite to pressures less than approximately 50,000 psi. In some embodiments, the method also includes pouring the lignin composite into a mold, and the pouring is performed prior to the compressing. In some embodiments, the model is in the shape of a brick.

An aspect of the present disclosure is a lignin-based structural material made up of a lignin-based precursor mixture, and an aggregate filler, in which the lignin-based precursor mixture includes a lignin, an acid, and a polymer. In some embodiments, the lignin is a dealkaline lignin. In some embodiments, the acid is a citric acid, a hydroxyl-containing acid polymer, and/or a carboxylic acid-containing polymer. In some embodiments, the polymer is poly(vinyl alcohol), cellulosic materials, hydroxyl-terminated poly(ethylene glycol), and/or poly(acrylic acid). In some embodiments, the aggregate filler is sand, silica, sandstone, limestone, and/or gravel. In some embodiments, the lignin-based structural material has a compressive strength of greater than approximately 10,000 psi. In some embodiments, the lignin-based structural material has a water resistance of greater than approximately 50%. In some embodiments, the lignin-based structural material may withstand a force of at least 90 psi for greater than thirty (30) days.

### BRIEF DESCRIPTION OF THE DRAWINGS

Some embodiments of the present disclosure are illustrated in the referenced figures of the drawings. It is intended that the embodiments and figures disclosed herein are to be considered illustrative rather than limiting.

FIG. 1 illustrates a method of making a lignin-based structural material, according to some aspects of the present disclosure.

FIG. 2 illustrates a method of making a lignin-based structural material including optional steps, according to some aspects of the present disclosure.

FIG. 3 illustrates a lignin-based structural material, according to some aspects of the present disclosure.

FIG. 4 exemplary samples of the lignin-based structural material, according to some aspects of the present disclosure.

FIG. 5 illustrates the measured conductivity as a function of temperature for an exemplary sample of the lignin-based structural material, according to some aspects of the present disclosure.

### REFERENCE NUMERALS

100 . . . method
105 . . . combining
110 . . . extruding
115 . . . mixing
120 . . . compressing
125 . . . pouring
130 . . . heating
135 . . . drying
140 . . . curing
200 . . . lignin-based structural material
205 . . . lignin
210 . . . acid
215 . . . polymer
220 . . . lignin-based precursor mixture
225 . . . aggregate filler
230 . . . lignin composite

### DETAILED DESCRIPTION

The embodiments described herein should not necessarily be construed as limited to addressing any of the particular problems or deficiencies discussed herein. References in the specification to “one embodiment”, “an embodiment”, “an example embodiment”, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some embodiments of the present invention, the term “substantially” is defined as approaching a specific numeric value or target to within 20%, 15%, 10%, 5%, or within 1% of the value or target. In further embodiments of the present invention, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to +20%, +15%, +10%, +5%, or +1% of a specific numeric value or target. In some embodiments of the present invention, the term “about” is used to indicate an uncertainty limit of less than or equal to +1%, +0.9%, +0.8%, +0.7%, +0.6%, +0.5%, +0.4%, +0.3%, +0.2%, or +0.1% of a specific numeric value or target.

Among other things, the present disclosure relates to a lignin-based structural material and a method of making the lignin-based structural material. The method of making the lignin-based structural material of this present disclosure may utilize significantly less energy than the manufacture of traditional structural materials (approximately 10 times lower embodied energy). The lignin-based structural material of the present disclosure may also be capable of mitigating carbon dioxide by sequestering carbon and thus offsetting emissions from traditional structural material manufacturing.

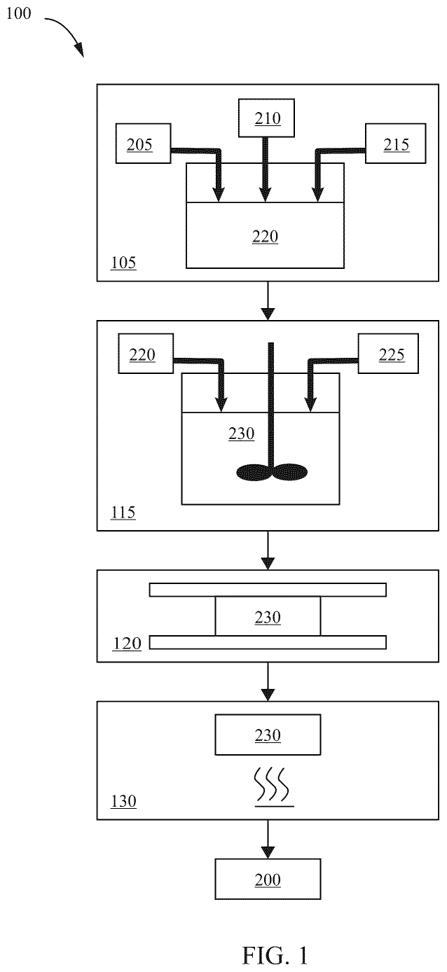

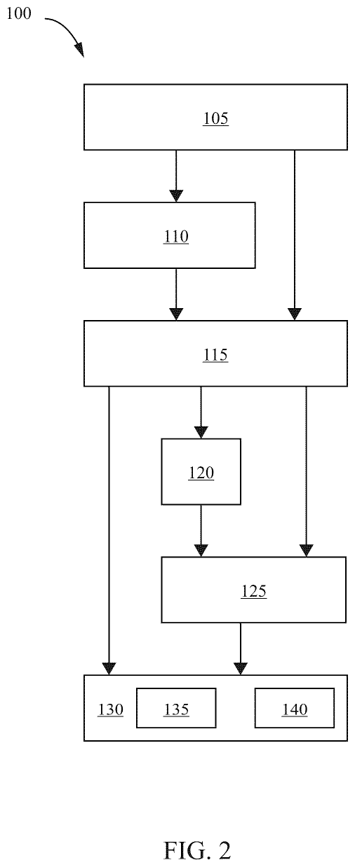

FIGS. 1-2 illustrate a method 100 of making a lignin-based structural material 200, according to some aspects of the present disclosure. FIG. 1 illustrates the method 100 in a visual way, including the steps and the components; FIG. 2 illustrates a flow chart of the method 100. In some embodiments, the method 100 of making a lignin-based structural material 200 first includes combining 105 lignin 205, with an acid 210 and a polymer 215 to form a lignin-based precursor mixture 220. In some embodiments, the combining 105 may be performed at a temperature of less than approximately 250° C.

As shown in FIG. 2, in some embodiments, after the combining 105, the next step in the method 100 may be extruding 110 the lignin-based precursor mixture 220 into a pellet form. Extruding 110 may make the lignin-based precursor mixture 220 easier to work with in the next step, mixing 115. In some embodiments, the method 100 does not include extruding, and the step following the combining 105 is mixing 115.

In some embodiments, the method 100 of making a lignin-based structural material 200 next includes mixing 115 the lignin-based precursor mixture 220 with an aggregate filler 225. In some embodiments, the lignin-based precursor mixture 220 may be in the form of pellets (if extruded 110) or in the form of a power or sludge. The aggregate filler 225 may include particles containing silicon oxide on the surface. In some embodiments, the lignin 105 may react with the silica in the aggregate filler 225. The mixing 115 may result in a lignin composite 230.

In some embodiments, as shown in FIG. 2, after the mixing 115, the next step in the method 100 may be pouring 120 the lignin composite 230. In some embodiments, the pouring 120 may be done into a mold. The mold may be used to shape the lignin composite 230 into the desired shape for the lignin-based structural material 200 (e.g., blocks or bricks). The mold may be reusable (i.e., after completing the method 100, the lignin-based structural material 200 may be removed from the mold and the mold may be used again). In some embodiments, the pouring 120 may be done into a form or space with only edging (i.e., pouring 120 a slab) into the place where the lignin-based structural material 200 is intended to be used. In some embodiments, the method 100 docs not include pouring 120, and the next step after the mixing 115 is compressing 125.

In some embodiments, the method 100 of making a lignin-based structural material 200 next includes compressing 125 the lignin composite 230. The lignin composite 230 may be compressed at pressures of up to approximately 50,000 psi. In some embodiments, the compressing 125 may be performed using a hydraulic press, a hot press, and/or a rosin press. In some embodiments, the compressing 125 may be performed using a vibratory roller or road roller. The compressing 125 may result in a reduction in the amount of void volume in the lignin composite 230, which increases the strength of the ultimate lignin-based structural material 200. In some embodiments, the lignin composite 230 may be compressed 125 in a mold or a location with edging, if pouring 120 is performed.

In some embodiments, the method 100 of making a lignin-based structural material 200 next includes heating 130 the lignin composite 230 to form the lignin-based structural material 200. This heating 130 may remove water and/or citric acid from the lignin composite 230, forming lignin-based structural material 200 that may be able to act as an alternative to concrete.

In some embodiments, the heating 130 may include at least one of drying 135 the lignin composite 230 and/or curing 140 the lignin composite. In some embodiments, the drying 135 may be done by allowing the lignin composite 230 to set at ambient conditions (i.e., the temperature, humidity, and pressure of the surrounding environment where the method 100 is being performed). In some embodiments, the drying 135 may be done by placing the lignin composite 230 in an oven or kiln. The oven or kiln may be heated to a temperature in the range of approximately 25° C. to approximately 100° C. In some embodiments, the oven or kiln may be heated to a temperature of approximately 60° C. In some embodiments, radiant heating elements, infrared lamps, or heating blankets may be used for the drying 135. The lignin composite 230 may be dried 135 until a portion of the water and/or acid 210 is removed from the lignin composite 230.

In some embodiments, the curing 140 may be done by placing the lignin composite 230 in an oven or kiln at a temperature in the range of about 25° C. to approximately 300° C. In some embodiments, radiant heating elements, infrared lamps, or heating blankets may be used for the curing 140. In some embodiments, the curing 140 may include adding a surfactant to the lignin composite 230. A surfactant may be a substance (for example, a detergent or soap) which when added to a liquid, reduces the surface tension of the liquid, thereby increasing its spreading and wetting properties. Exemplary surfactants may include sodium alkylbenzene sulfonates, sodium stearate, soap, and/or potassium alcohol sulfates. The surfactant does not impact the strength of the final material by may impact the stickiness of the surface.

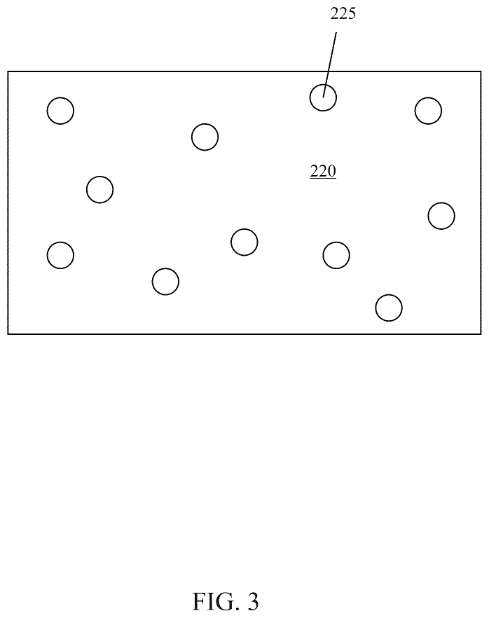

In some embodiments, as shown in FIG. 3 the lignin-based structural material 200 is composed of a lignin-based precursor mixture 220 and an aggregate filler 225. As shown in FIG. 1, the lignin-based precursor mixture 220 may be made of a combination of lignin 205, an acid 210, and a polymer 215. In some embodiments, the lignin-based precursor mixture 220 may be mixed with a relatively inert solvent, such as water (not shown in FIG. 1 or 3).

In some embodiments, the lignin 205 may be dealkaline lignin (i.e., lignin where at least a portion of acidic groups are pronated), alkaline lignin (i.e., lignin where at least a portion of acidic groups are neutralized) and/or lignosulfonates. In some embodiments, the lignin may be at least partially acidified meaning that at least approximately 1% of carboxylates and/or phenols in the lignin 205 are pronated. In some embodiments, the lignin 205 may be from plants (for example, needle leafed or broad-leafed tress). In some embodiments, the lignin 205 may be from pulp or a by-product from the paper industry. In some embodiments, the lignin 205 may be from corn stover waste. In some embodiments, the lignin 205 may be extracted from an organosolv process. In some embodiments, the lignin may be alkaline lignin. In some embodiments, the lignin may be from wood (such as oak, walnut, cedar, maple, birch, hickory, pine, teak, cherry, balsa, elm, ash, mahogany, walnut, alder, spruce, fir, and/or redwood).

In some embodiments, the polymer 215 may be hydroxyl- or carboxylic acid-containing. Exemplary polymers 215 include poly(vinyl alcohol) (PVA), cellulosic materials, poly(ethylene glycol), hydroxyl-alkyl acrylate, methacrylate (i.e., hydroxyethyl methacrylate-containing polymers) and/or poly(acrylic acid), which may or may not be terminated with a hydroxyl group. In some embodiments, the polymer 215 may comprise an esterification or a transesterification catalyst. Examples of esterification and transesterification catalysts include Ti and Sb based catalysts, for example titanium butoxide, antimony oxide and related compounds. The polymer 215 may react with carboxylic groups on the lignin 205 and/or the acid 210. The polymer 215 may serve as a compatibilizer, foaming agent, and/or improve the stability of all the components within the lignin-based precursor mixture 220.

In some embodiments, the aggregate filler 225 may be at least one of cement, calcium silicate, or calcium oxide to provide the energy needed to initiate the heating process. This aggregate filler 225 may also provide additional strength to the file lignin-based structural material 200. In some embodiments the aggregate filler 225 may be in the form of substantially smooth spheres or jagged irregularly-shaped particles which may range in size from approximately 100 nm to approximately 10 cm in diameter. In some embodiments, the aggregate filler 225 may also include sand, silica, sandstone, limestone, and/or gravel. In some embodiments, the aggregate filler 225 may also include waste materials, such as wood shards, particle board, sawdust, plastic, recycled plastic, gypsum, glass, glass fibers, fiberglass, paper, paperboard, cardboard, cement, concrete, rubber, and/or metal.

In some embodiments, the acid 210 may be an acid that has at least two carboxylic acid groups. The carboxylic acid groups may serve as a crosslinker (i.e., can react with multiple hydroxyl groups within the lignin 205 and/or polymer 215). Exemplary acids 210 include citric acid, adipic acid, or other multi-functional carboxylic acids.

In some embodiments, lignin 205 may be crosslinked while going through the method 100 using at least one of: 1) Fischer esterification, 2) epoxidation of alcohol groups followed by a reaction with amines, anhydrides, phenols, or thiols, 3) reaction with isocyanates, 4) ether formation (e.g., Williamson synthesis or solvolysis), or other processes. Esterification reactions are reversible in nature and require significantly lower temperatures (approximately 200° C.) than those for traditional cement production (approximately 1500° C.). In some embodiments, esterification catalysts (i.e., polymers 215) may be used to catalyze esterification of terephthalic acid with ethylene glycol. Exemplary esterification catalysts may include Ti-alkoxide catalysts used at relatively low levels (e.g., less than approximately 0.1%). Esterification reactions may lower the time required to cure the resulting material. The lignin-based structural materials 200 containing crosslinked polymers can exhibit high strength (as shown in Table 1). Foams (mostly air) of crosslinked lignin 205 have been shown to have a compressive strength of approximately 4.74 MPa. In some embodiments, the compressive strength of the lignin-based structural materials 200 may be increased through further optimization of the density, crosslink concentration, and/or chemistry of the lignin 205. This may result in a lignin-based structural material 200 which functions like an epoxy resin (see Table 1). This cross-linked lignin-based material may be thermoset, e.g., incapable of being melted.

Cement may be used as a co-binder and also a heat generator for endothermic reactions, forming a dual cure system. A dual cure system uses complementary polymerization in which the exothermic nature of one reaction simultaneously drives a secondary polymerization reaction to generate one or more polymeric materials, including crosslinked polymer matrices, tethered inter-penetrating network, heterogenous polymer blends, or homogeneous polymer blends. This may also for cross-linking of the lignin-composite molecules to occur, thereby increasing material strength and stability. The heat generation may drive the crosslinking polymerization described herein.

Table 1 shows preliminary results comparing the lignin-based structural material 200 to common structural materials The sample of lignin-based structural material 200 tested was composed of approximately 90% sand (i.e., the aggregate filler 225), approximately 6% lignin 205, and approximately 4% additives (i.e., acid 210 (citric acid) and polymer 215 (poly(vinyl alcohol) (PVA)). Additives may include NaCl.

TABLE 1
Comparison of common building materials
and the lignin-based structural material.

| | Compressive | Global Volume | Cost | CO₂ Impact |
|---|---|---|---|---|
| Material | Strength (MPa) | (Mt/yr) | ($/ton) | (Mt/yr) |
| Brick | 10 | 900 | ~$240 | +300 |
| Concrete | 17-70 | 30,000 | ~$50-100 | +3,000 |
| Wood | 30 (parallel | 700 | ~$140 | +400 |
| | to the grain) | | | |
| Epoxy | 60-170 | — | ~$6,000 | — |
| Lignin-based | ~70 | Up to 5,000 | ~$50-100 | −700 |
| structural | | | | |
| material 200 | | | | |

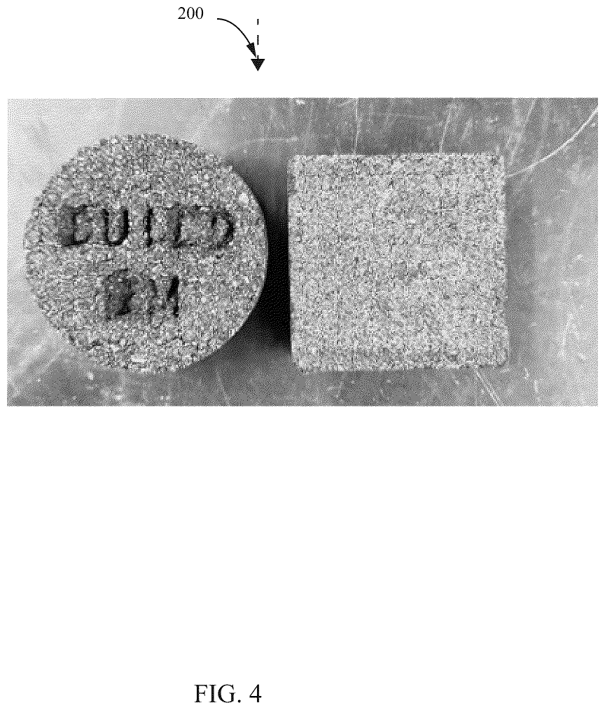

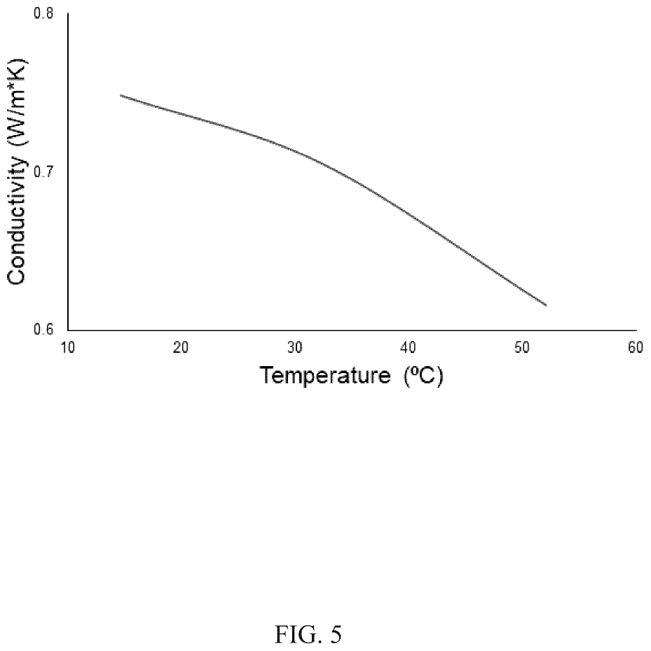

FIG. 4 illustrates photos of exemplary samples of the lignin-based structural material 200, according to some aspects of the present disclosure. The exemplary samples were made using lignin 205 from broad leafed or needle leafed trees. In experiments, the samples of lignin-based structural material 200 showed a compressive strength of greater than approximately 3,000 psi. This is impressive because the aggregate filler 225 (and the source of SiO₂) used, sand, is a relatively low-strength aggregate filler 125. The samples of the lignin-based structural material 200 showed a density that was approximately one half (½) that of traditional concrete. The samples of lignin-based structural material 200 showed similar conductivity to traditional concrete (see FIG. 5). The conductivity shown by the samples of the lignin-based structural material 200 lies within the conductivity range of traditional building materials (i.e., in the range of approximately 0.4 W/m*K to approximately 1.4 W/m*K).

In some embodiments, the lignin-based structural material 200 may have a compressive strength of up to approximately 9,700 psi. Samples of exemplary lignin-based structural materials 200 (as shown in FIG. 4) may have a water resistance of greater than approximately 50%, meaning that they can maintain at least approximately 50% of their compressive strength after being soaked in water for approximately thirty (30) days. In initial tests, the samples of exemplary lignin-based structural material 200 (as shown in FIG. 4) were shown to withstand a force of at least approximately 90 psi for approximately six months.

In some embodiments, the lignin-based structural material 200 may have a resistance to ultraviolet (UV) light from the sun because the outermost layer of aromatic lignin 105 in the lignin-based structural material 200 can act as a sacrificial absorbing layer. The lignin 105 in the lignin-based structural material 200 may have charring ability and may reduce oxygen flow to the aggregate filler 125, which increases the fire resistance of the lignin-based structural material 200. The lignin-based structural material 200 may have freeze-thaw resistance by having a reduced porosity compared to traditional structural materials.

In some embodiments, the lignin-based structural materials 200 may be used for carbon sequestration. This is because by utilizing the lignin 105 rather than burning the lignin 105 as a fuel source, carbon is not released into the atmosphere. Additionally, using a lower manufacturing temperature (approximately 150° C.) than traditional structural materials (approximately 1400° C.) results in significantly less energy used to manufacture the lignin-based structural materials 200.

### EXAMPLES

Example 1. A method comprising:
combining a lignin, an acid, and a polymer to form a cross-linked, thermoset lignin-based precursor mixture;
mixing the lignin-based precursor mixture and an aggregate filler resulting in a lignin composite;
compressing the lignin composite; and
heating the lignin composite resulting in a lignin-based structural material.

Example 2. The method of Example 1, wherein:
the lignin comprises dealkaline lignin (i.e., lignin where at least a portion of acidic groups are pronated), alkaline lignin (i.e., lignin where at least a portion of acidic groups are neutralized) and/or lignosulfonates.

Example 3. The method of Example 2, wherein:
the lignin is partially acidified.

Example 4. The method of Examples 1-3, wherein:
the acid comprises at least one of citric acid, lactic acid, or carboxylic acid.

Example 5. The method of Examples 1-4, wherein:
the polymer comprises at least one of a hydroxyl group or a carboxylic acid.

Example 6. The method of Examples 1-5, wherein:
the polymer comprises at least one of poly(vinyl alcohol), hydroxyl-terminated poly(ethylene glycol), hydroxyl-alkyl acrylate, methacrylate, hydroxyethyl methacrylate-containing polymers, poly(acrylic acid) or a combination thereof.

Example 7. The method of Examples 1-6, wherein:
the aggregate filler comprises at least one of sand, cement, silica, sandstone, limestone, or gravel.

Example 8. The method of Examples 1-7, wherein:
the aggregate filler comprises at least one of wood shards, sawdust, plastic, gypsum, glass, glass fibers, paper, concrete, cement, rubber, or metal.

Example 9. The method of Examples 1-8, wherein:
the combining is performed at a temperature of less than approximately 100° C.

Example 10. The method of Examples 1-9, wherein:
the step of heating comprises:
drying the lignin composite.

Example 11. The method of Example 10, wherein:
the drying comprises exposing the lignin composite to ambient conditions.

Example 12. The method of Examples 10 or 11, wherein:
the drying comprises placing the lignin composite in an oven, and the oven has a temperature of approximately 100° C.

Example 13. The method of Examples 1-12, wherein:
the step of heating comprises:
curing the lignin composite.

Example 14. The method of Example 13, wherein:
the step of curing is performed at a temperature of less than approximately 300° C.

Example 15. The method of Example 13, wherein:
the step of curing is performed at a temperature of approximately 150° C.

Example 16. The method of Examples 1-15, wherein:
the compressing comprises exposing the lignin composite to pressures less than approximately 50,000 psi.

Example 17. The method of Examples 1-16, wherein:
the compressing is performed using at least one of a hydraulic press, a hot press, or a rosin press.

Example 18. The method of Examples 1-17, wherein:
the lignin-based structural material has a compressive strength of greater than approximately 5,000 psi.

Example 19. The method of Examples 1-18, wherein:
the lignin-based structural material has a water resistance of greater than approximately 50%.

Example 20. The method of Examples 1-19, wherein:
the lignin-based structural material may withstand a force of at least 90 psi for greater than six months.

Example 21. The method of Examples 1-20, further comprising:
extruding the lignin-based precursor mixture into a pellet form; wherein:
the extruding is performed prior to the mixing.

Example 22. The method of Examples 1-21, further comprising:
pouring the lignin composite into a mold; wherein:
the pouring is performed prior to the compressing.

Example 23. The method of Example 22, wherein:
the mold comprises the shape of a brick.

Example 24. The method of Examples 1-23 wherein the polymer further comprises an esterification catalyst comprising Ti or Sb.

Example 25. The method of Examples 10-24, wherein the step of curing comprises adding a surfactant to the lignin composite.

Example 26. The method of Example 25, wherein the surfactant comprises at sodium alkylbenzene sulfonates, sodium stearate, soap, potassium alcohol sulfates, or a combination thereof.

Example 27. A lignin-based structural material comprising:
a cross-linked, thermoset lignin-based precursor mixture, and
an aggregate filler; wherein:
the lignin-based precursor mixture comprises a lignin, an acid, and a polymer.

Example 28. The lignin-based structural material of Example 27, wherein:
the lignin comprises dealkaline lignin.

Example 29. The lignin-based structural material of Example 27, wherein:
the lignin is partially acidified.

Example 30. The lignin-based structural material of Examples 26-29, wherein:
the acid comprises at least one of citric acid, lactic acid, a hydroxyl-containing acidic polymer, or a carboxylic acid-containing polymer.

Example 31. The lignin-based structural material of Examples 27-30 wherein:
the polymer comprises at least one of a hydroxyl group or a carboxylic acid.

Example 32. The lignin-based structural material of Examples 27-31, wherein:
the polymer comprises at least one of comprises at least one of poly(vinyl alcohol), cellulosic materials, hydroxyl-terminated poly(ethylene glycol), hydroxyl-alkyl acrylate, methacrylate, hydroxyethyl methacrylate-containing polymers, poly(acrylic acid) or a combination thereof.

Example 33. The lignin-based structural material of Examples 27-32, wherein:
the aggregate filler comprises at least one of sand, silica, sandstone, limestone, or gravel.

Example 34. The lignin-based structural material of Examples 27-33, wherein:
the aggregate filler material comprises at least one of wood shards, sawdust, plastic, gypsum, glass, glass fibers, paper, concrete, rubber, or metal.

Example 35. The lignin-based structural material of Examples 27-34, wherein:
the lignin-based structural material has a compressive strength of greater than approximately 10,000 psi.

Example 36. The lignin-based structural material of Examples 27-35, wherein:
the lignin-based structural material has a compressive strength of approximately 9,700 psi.

Example 37. The lignin-based structural material of Examples 27-36, wherein:
the lignin-based structural material has a water resistance of greater than approximately 50%.

Example 38. The lignin-based structural material of Examples 27-37, wherein:
the lignin-based structural material may withstand a force of at least 90 psi for greater than six months.

The foregoing discussion and examples have been presented for purposes of illustration and description. The foregoing is not intended to limit the aspects, embodiments, or configurations to the form or forms disclosed herein. In the foregoing Detailed Description for example, various features of the aspects, embodiments, or configurations are grouped together in one or more embodiments, configurations, or aspects for the purpose of streamlining the disclosure. The features of the aspects, embodiments, or configurations may be combined in alternate aspects, embodiments, or configurations other than those discussed above. This method of disclosure is not to be interpreted as reflecting an intention that the aspects, embodiments, or configurations require more features than are expressly recited in each claim. Rather, as the following claims reflect, inventive aspects lie in less than all features of a single foregoing disclosed embodiment, configuration, or aspect. While certain aspects of conventional technology have been discussed to facilitate disclosure of some embodiments of the present invention, the Applicants in no way disclaim these technical aspects, and it is contemplated that the claimed invention may encompass one or more of the conventional technical aspects discussed herein. Thus, the following claims are hereby incorporated into this Detailed Description, with each claim standing on its own as a separate aspect, embodiment, or configuration.

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods and devices useful for the present methods can include a large number of optional composition and processing elements and steps.

As used herein and in the appended claims, the singular forms “a”, “an”, and “the” include plural reference unless the context clearly dictates otherwise. Thus, for example, reference to “a cell” includes a plurality of such cells and equivalents thereof known to those skilled in the art. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

When a group of substituents is disclosed herein, it is understood that all individual members of that group and all subgroups, are disclosed separately. When a Markush group or other grouping is used herein, all individual members of the group and all combinations and subcombinations possible of the group are intended to be individually included in the disclosure. For example, when a device is set forth disclosing a range of materials, device components, and/or device configurations, the description is intended to include specific reference of each combination and/or variation corresponding to the disclosed range.

Every formulation or combination of components described or exemplified herein can be used to practice the invention, unless otherwise stated.

Whenever a range is given in the specification, for example, a density range, a number range, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when composition of matter is claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

What is claimed is:

1. A method comprising:
combining a lignin, an acid, and a polymer to form a cross-linked, thermoset lignin-based precursor mixture;
mixing the lignin-based precursor mixture and an aggregate filler resulting in a lignin composite;
compressing the lignin composite; and
heating the lignin composite resulting in a lignin-based structural material.

2. The method of claim 1, wherein:
the lignin comprises dealkaline lignin.

3. The method of claim 1, wherein:
the acid comprises at least one of citric acid, lactic acid, a hydroxyl-containing acidic polymer, or a carboxylic acid-containing polymer.

4. The method of claim 1, wherein:
the polymer comprises at least one of poly(vinyl alcohol), cellulosic materials, hydroxyl-terminated poly(ethylene glycol), hydroxyl-alkyl acrylate, methacrylate, hydroxyethyl methacrylate-containing polymers, poly(acrylic acid) or a combination thereof.

5. The method of claim 1, wherein:
the polymer comprises an esterification catalyst comprising Ti or Sb.

6. The method of claim 1, wherein:
the aggregate filler comprises at least one of sand, cement, silica, sandstone, limestone, or gravel.

7. The method of claim 1, wherein:
the heating comprises:
drying the lignin composite, and
curing the lignin composite.

8. The method of claim 7, wherein:
the step of drying comprises exposing the lignin composite to ambient conditions.

9. The method of claim 7, wherein:
the step of curing is performed at a temperature of less than approximately 300° C.

10. The method of claim 7, wherein:
the step of curing comprises adding a surfactant to the lignin composite.

11. The method of claim 10, wherein:
the surfactant comprises at least one of sodium alkylbenzene sulfonates, sodium stearate, soap, and/or potassium alcohol sulfates.

12. The method of claim 1, wherein:
the compressing comprises exposing the lignin composite to pressures less than approximately 50,000 psi.

13. The method of claim 1, further comprising:
pouring the lignin composite into a mold; wherein:
the pouring is performed prior to the compressing.

14. A lignin-based structural material comprising:
a cross-linked, thermoset lignin-based precursor mixture, and
an aggregate filler; wherein:
the lignin-based precursor mixture comprises a lignin, an acid, and a polymer.

15. The lignin-based structural material of claim 14, wherein:
the lignin comprises dealkaline lignin.

16. The lignin-based structural material of claim 14, wherein:
the acid comprises at least one of citric acid, lactic acid, a hydroxyl-containing acid polymer, or a carboxylic acid-containing polymer.

17. The lignin-based structural material of claim 14, wherein:
the polymer comprises at least one of poly(vinyl alcohol), cellulosic materials, hydroxyl-terminated poly(ethylene glycol), hydroxyl-alkyl acrylate, methacrylate, hydroxyethyl methacrylate-containing polymers, poly(acrylic acid) or a combination thereof.

18. The lignin-based structural material of claim 14, wherein:
the aggregate filler comprises at least one of sand, cement, silica, sandstone, limestone, or gravel.

19. The lignin-based structural material of claim 14, wherein:
the lignin-based structural material has a compressive strength of greater than approximately 10,000 psi.

20. The lignin-based structural material of claim 14, wherein:
the lignin-based structural material has a water resistance of greater than approximately 50%.
